(19) United States
(12) Patent Application Publication
(10) Pub. No.: US 2022/0251963 A1
(43) Pub. Date: Aug. 11, 2022

(54) RING FOR A TURBOMACHINE OR A TURBOSHAFT ENGINE TURBINE

(71) Applicant: SAFRAN HELICOPTER ENGINES, Bordes (FR)

(72) Inventors: Bertrand Guillaume Robin PELLATON, MOISSY-CRAMAYEL (FR); Mathieu Laurent HERRAN, MOISSY-CRAMAYEL (FR); Yohan SMITH, MOISSY-CRAMAYEL (FR)

(73) Assignee: SAFRAN HELICOPTER ENGINES, Bordes (FR)

(21) Appl. No.: 17/630,454

(22) PCT Filed: Aug. 4, 2020
(86) PCT No.: PCT/FR2020/051433

§ 371 Date: Jan. 26, 2022

(30) Foreign Application Priority Data
Aug. 5, 2019 (FR) 1908957

(51) Int. Cl. F01D 11/04

(52) U.S. Cl. CPC F01D 11/04

(57) ABSTRACT

The invention relates to a ring (1) for a turbomachine turbine or a turboshaft engine turbine, intended to surround an impeller (2) of a turbine rotor, the said ring (1) extending circumferentially about an axis and comprising an annular and continuous support part (9), radially external, and a part (10) delimiting a circulation passage (6) of a gas flow, radially internal and comprising a plurality of angular segments (13) distributed over the periphery and situated adjacent to one another so as to form an annular part delimiting the passage (6), characterised in that circumferential clearances (j) are formed between the circumferential ends of the adjacent segments (13) located opposite each other, each segment (13) being connected to the support part (9) by means of a connecting zone (14), an annular channel (15) for the circulation of cooling fluid being delimited radially between the outer support part (9) and the inner part (10) delimiting the passage.

### TECHNICAL FIELD OF THE INVENTION

The invention relates to a ring for a turbomachine turbine or a turboshaft engine turbine, intended to surround an impeller of a turbine rotor.

### PRIOR ART

A turbomachine typically comprises, from upstream to downstream in the direction of flow of the gases, a blower, a low-pressure compressor, a high-pressure compressor, a combustion chamber, a high-pressure turbine and a low-pressure turbine.

The air stemming from the blower is divided into a primary flow flowing in a primary annular passage, and a secondary flow flowing in a secondary annular passage surrounding the primary annular passage.

The low-pressure compressor, the high-pressure compressor, the combustion chamber, the high-pressure turbine and the low-pressure turbine are located in the primary passage.

The rotor of the high-pressure turbine and the rotor of the high-pressure compressor are coupled in rotation via a first shaft so as to form a high-pressure body.

The rotor of the low-pressure turbine and the rotor of the low-pressure compressor are coupled in rotation via a second shaft so as to form a low-pressure body, the blower being able to be connected directly to the rotor of the low-pressure compressor or via an epicyclic gear train for example.

The rotors of the high-pressure and low-pressure turbines have impellers surrounded by a ring belonging to the stator. In order to optimise the performance of the turbomachine, the radial clearances between the radially outer ends or tips of the vanes and the radially inner surface of the ring delimiting the flow-passage of the warm gases must be limited. The definition of these clearances must in particular take into account the expansion phenomena of the parts in operation.

The smaller the clearances, the better the performance of the turbomachine, since almost all of the airflow is used to rotate the turbine. Conversely, the presence of large clearances penalizes the efficiency of the turbomachine.

It is known to use single-piece rings, i.e. rings formed in one piece, thus reducing the cost, weight and radial footprint of the turbine. However, the single-piece rings currently in use are only designed to work optimally within a limited temperature range. Outside this temperature range, the radial clearances between the tips of the vanes and the ring are significant and penalise the efficiency of the turbomachine.

It is known to use a sectorised ring, i.e. composed of several adjacent angular sectors, placed end-to-end to form a ring. Such a ring allows for finer control of the clearances between the ring sectors and the tips of the vanes, but is heavy, has a high radial dimension and is expensive.

The invention aims to remedy such drawbacks in a simple, reliable and inexpensive way.

### DISCLOSURE OF THE INVENTION

For this purpose, the invention relates to a single-piece ring for a turbomachine turbine, intended to surround an impeller of a turbine rotor, the said ring extending circumferentially about an axis and comprising an annular and continuous support part, radially external, and a part delimiting a circulation passage of a gas flow, radially internal and comprising a plurality of angular segments distributed over the periphery and situated adjacent to one another so as to form an annular part delimiting the passage, characterised in that circumferential clearances are formed between the circumferential ends of the adjacent segments located opposite each other, each segment being connected to the support part by means of a connecting zone, an annular channel for the circulation of cooling fluid being delimited radially between the outer support part and the inner part delimiting the passage.

The presence of an annular channel for the circulation of cooling air allows for the segments of the inner part to be cooled effectively, since these segments are subjected to high temperatures. In addition, the presence of circumferential clearances between the segments limits radial expansions.

Such a single-piece structure is also inexpensive, reliable and has a small footprint.

The radially outer support part is annular and continuous, i.e. not segmented. In other words, the radially outer support part extends in one piece around the entire circumference.

Each connecting zone can extend circumferentially a shorter distance than the corresponding segment of the radially inner part delimiting the passage. The circumferential dimension of each sector of the radially inner part is, for example, greater than 5 times the circumferential distance of the corresponding connecting zone.

Each connecting zone can be formed by a flat partition. The said partition can extend in a radial plane oriented in the axial direction.

The ring can include a means of sealing between the inner and outer parts, said means of sealing being capable of allowing a cooling-air leakage rate stemming from the channel.

The means of sealing make it possible to limit and to control the leakage rate, with the air stemming from this leakage entering, for example, the flow-passage of the warm gases or the primary passage.

The means of sealing can comprise at least one annular seal mounted radially between the inner and outer parts.

The means of sealing can comprise a first annular seal and a second annular seal located at a first axial end and a second axial end of the channel respectively.

Each annular seal can be engaged partially in a groove located in the inner part and/or in a groove located in the outer part.

Each annular seal can have a polygonal, e.g. square, or a rounded, e.g. circular or oval cross-section.

The grooves can have forms complementary to the annular seals.

The means of sealing can comprise at least one labyrinth seal.

The labyrinth seal can have one or more radial annular flanges extending from the inner part, axially interposed between one or more radial annular flanges extending from the outer part, or vice versa.

Such a seal makes it possible to control the pressure drops and therefore the leakage rate.

The means of sealing can comprise a first labyrinth seal and a second labyrinth seal located at a first axial end and a second axial end of the channel respectively.

The ring can have air-inlet orifices to allow cooling air to enter the channel.

The air-inlet orifices can extend radially.

The air-inlet orifices can be located in the outer part of the support.

The air-inlet orifices can be evenly distributed around the periphery.

The air-inlet orifices can have a polygonal cross-section, or a rounded cross-section, for example circular.

Each segment can comprise a first circumferential end comprising an annular support rim extending circumferentially and capable of coming to bear on the radially outer surface of a second circumferential end of an adjacent segment.

The support rim can thus be located at the cooling-air circulation channel.

Each segment can comprise a first zone extending circumferentially between the first circumferential end of the segment and the connecting zone and a second zone extending circumferentially between the second circumferential end of the segment and the connecting zone, the circumferential dimension of the first zone being smaller than the circumferential dimension of the second zone.

The ratio of the circumferential dimension of the first zone to the circumferential dimension of the second zone is for example between 1 and 10.

Such a structure ensures that, in operation, the effects of expansion press the radially outer surface of the second circumferential end of each segment bearing on the corresponding support rim of the adjacent segment.

At least some of the air-inlet orifices can be located at the level of at least one connecting zone.

Such a structure makes it possible to cool each relevant connecting zone efficiently.

The outer part can have a thickness greater than the thickness of the inner part, for example 1.2 to 3 times the thickness of the inner part. This ensures better control of the clearances and a better retention of the blades in case of accidental release.

The ring can be made by additive manufacturing.

Such a process makes it possible to produce a ring with a complex structure, in a single piece, without the need for numerous and costly additional machining or assembly steps, so as to obtain a finished or almost finished ring ready for use.

The additive manufacturing process is, for example, sintering or selective powder melting, for example using a laser or electron beam.

Such a process comprises a step during which a first layer of powder of a metal or metal alloy of controlled thickness is deposited on a manufacturing plate, followed by a step consisting of heating with a means of heating (a laser beam or an electron beam) a predefined zone of the layer of powder, and proceeding by repeating these steps for each additional layer, until the final part is obtained, slice by slice.

The invention also relates to a turbine, e.g. a high-pressure turbine, a turbomachine or a turboshaft engine, or an aircraft comprising such a ring.

The turbomachine can be an aircraft turbomachine. The turboshaft engine can be a helicopter turboshaft engine.

### BRIEF DESCRIPTION OF THE FIGURES

FIG. 1 is a perspective view, with partial removal, of a part of a ring according to a first embodiment of the invention,

FIG. 2 is a view corresponding to FIG. 1, in which the annular seals are not shown,

FIG. 3 is a schematic view illustrating a radial cross-section of a part of the ring,

FIG. 4 is a view corresponding to FIG. 3, illustrating a second embodiment of the invention,

FIG. 5 is a perspective view of a part of a ring according to a third embodiment of the invention,

FIG. 6 is a perspective view of a part of a ring according to a fourth embodiment of the invention.

### DETAILED DESCRIPTION OF THE INVENTION

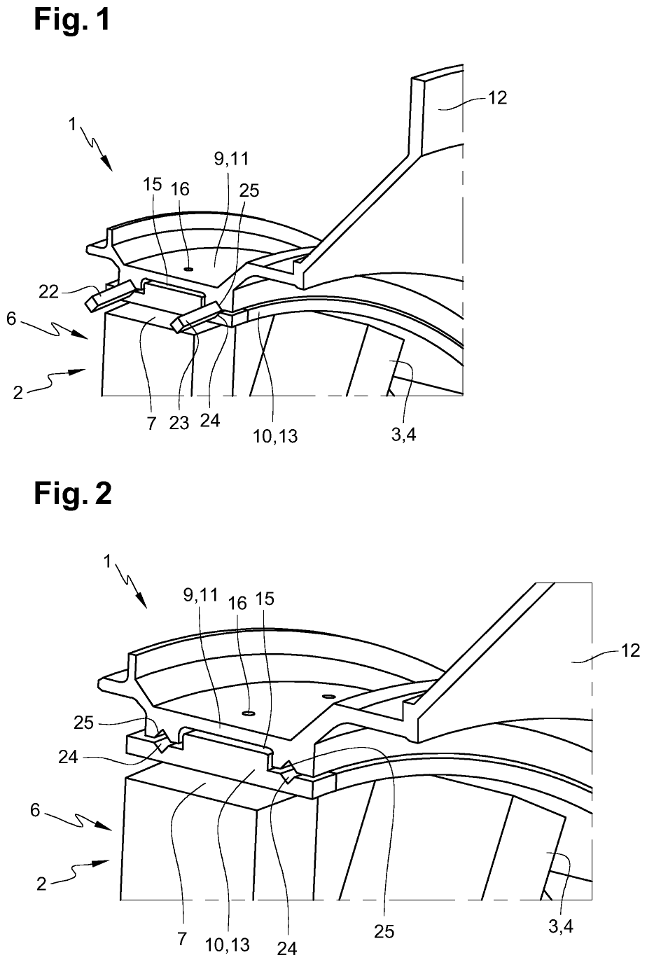

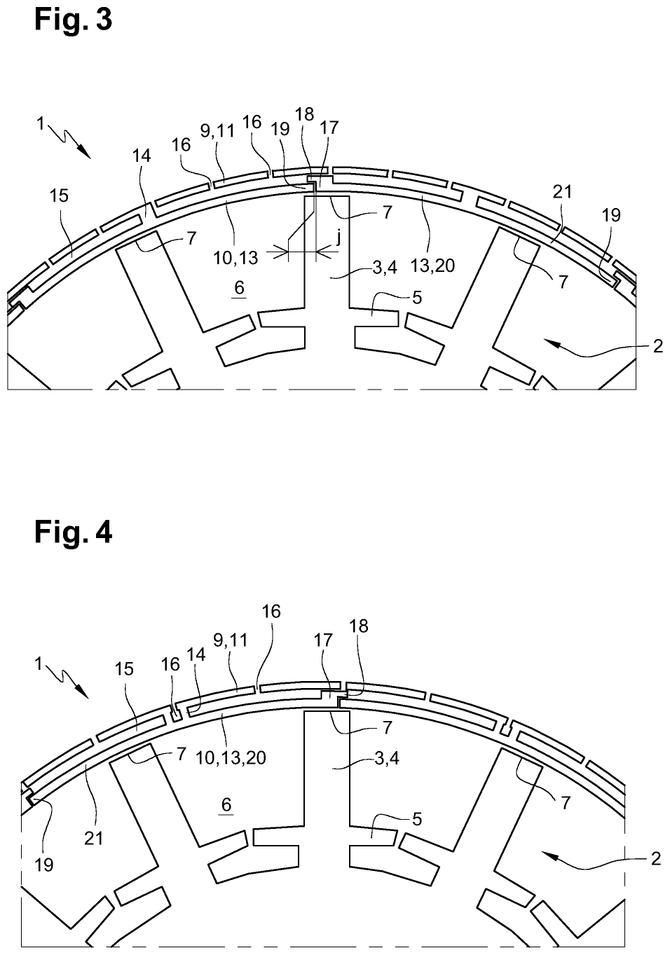

FIGS. 1 to 3 illustrate a ring 1 for a turbomachine turbine or a turboshaft engine turbine, for example a high-pressure or a low-pressure turbine, according to a first embodiment of the invention.

The ring 1 is intended to surround an impeller 2 of a turbine rotor.

The impeller has vanes 3 evenly spaced around the circumference, each vane having a blade 4 and a radially inner platform 5, internally delimiting a flow-passage 6 for a gas flow. The radially outer ends 7 of the vanes 3 are located close to the ring 1.

The ring 1 extends circumferentially around the axis of rotation of the rotor and comprises an annular and continuous support part 9, radially outer, and a radially inner part 10 externally delimiting the passage 6.

The outer part 9 has an axially central cylindrical zone 11 and at least one attachment zone 12 intended to be attached to a stator of the turbomachine.

The said inner part 10 comprises a plurality of angular segments 13 distributed around the periphery and located adjacent to each other so as to form an annular part delimiting the passage 6. Each segment 13 is connected to the support part 9 via a connecting zone 1 extending radially. The number of segments can vary depending on the end-use and is for example between 3 and 30.

An annular channel 15 for the circulation of cooling fluid is radially delimited between the external part 9 and the internal part 10 delimiting the passage 6.

The cylindrical zone 11 of the radially outer part 9 comprises air-inlet orifices 16 evenly distributed around the circumference and opening out radially into the channel 15. The air-inlet orifices 16 each have a rectangular or square cross-section. Of course, other forms can be used.

Each segment 13 comprises a first circumferential end 17 comprising an annular support rim 18 extending circumferentially and capable of coming to bear, during operation of the turbomachine or turboshaft engine, on the radially outer surface of a second circumferential end 19 of an adjacent segment 13. The support rim 18 is thus located at the cooling-air circulation channel 15.

Each segment 13 comprises a first zone 20 extending circumferentially between the first circumferential end 17 of the segment 13 and the connecting zone 14 and a second zone 21 extending circumferentially between the second circumferential end 19 of the segment 13 and the connecting zone 14. The circumferential dimension of the first zone 20 is smaller than the circumferential dimension of the second zone 21.

The ratio of the circumferential dimension of the first zone 20 to the circumferential dimension of the second zone 21 is for example between 1 and 10.

The outer part 9 can have a thickness greater than the thickness of the inner part 10, for example 1.2 to 3 times the thickness of the inner part 10. This ensures better control of the clearances and a better retention of the blades in case of accidental release.

The ring 1 further comprises a means of sealing comprising a first annular seal 22 and a second annular seal 23 located respectively at a first axial end and at a second axial end of the channel 15.

Each annular seal 22, 23 is partially engaged in a groove 24 located in the inner part 10 and in a groove 25 located in the outer part 9. Each annular seal 22, 23 can have a polygonal, e.g. square, or a rounded, e.g. circular or oval cross-section. The grooves 24, 25 are complementary in form to the annular seals 22, 23.

The ring 1 can be produced by additive manufacturing, in particular by sintering or selective powder fusion, for example using a laser beam or an electron beam.

FIG. 4 illustrates a second embodiment in which some of the air-inlet orifices 16 are located at the connecting zones 14, so as to effectively cool each concerned connecting zone 14.

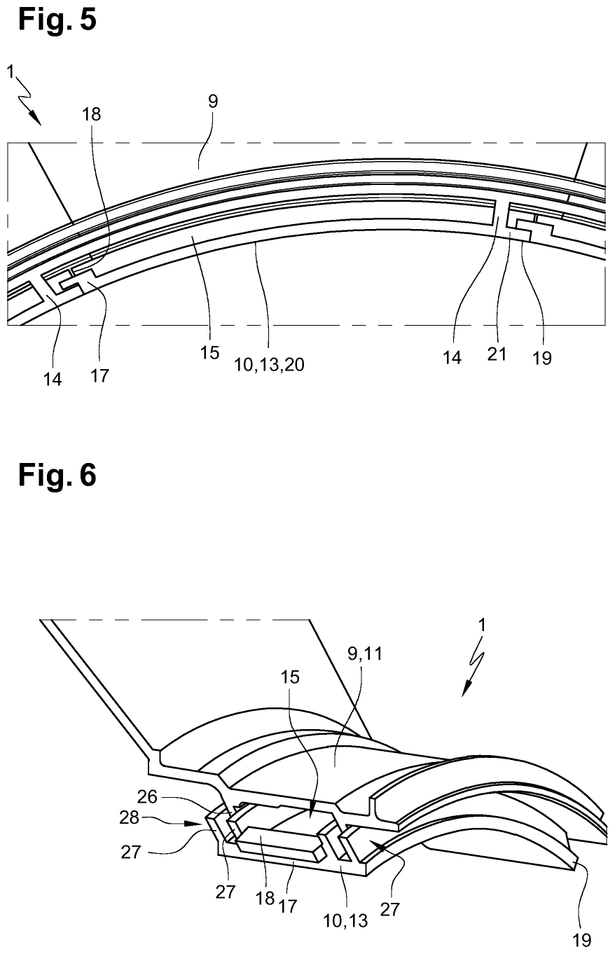

FIG. 5 illustrates a third embodiment in which the circumferential dimension of the first zone 20 is larger than the circumferential dimension of the second zone 21. The ratio of the circumferential dimension of the first zone 20 to the circumferential dimension of the second zone 21 is for example between 1 and 10.

FIG. 6 illustrates a fourth embodiment in which the means of sealing comprises a first labyrinth seal 26 and a second labyrinth seal 27 located at the first and second axial ends of the channel 15 respectively.

The labyrinth seal 26, 27 can have one or more radial annular rims 27 extending from the inner part 10, axially interposed between one or more radial annular rims 28 extending from the outer part 9, or vice versa.

1. A single-piece ring for a turbomachine turbine or a turboshaft engine turbine, configured to surround an impeller of a turbine rotor, the ring extending circumferentially about an axis and comprising an annular and continuous support part, radially external, and a part delimiting a circulation passage of a gas flow, radially internal and comprising a plurality of angular segments distributed over the periphery and situated adjacent to one another to form an annular part delimiting the passage wherein circumferential clearances are formed between the circumferential ends of the adjacent segments located opposite each other, each segment being connected to the support part by means of a connecting zone, an annular channel for the circulation of cooling fluid being delimited radially between the outer support part and the inner part delimiting the passage.

2. A ring according to claim 1, further comprising a means of sealing between the inner and outer parts, the means of sealing being configured to allow a cooling-air leakage rate stemming from the channel.

3. A ring according to claim 2, wherein the means of sealing comprises at least one annular seal mounted radially between the inner and outer parts.

4. A ring according to claim 3, wherein each annular seal is partially engaged in a groove located in the inner part and/or in a groove located in the outer part.

5. A ring according to claim 2, wherein the means of sealing comprises at least one labyrinth seal.

6. A ring according to claim 1, further comprising air-inlet orifices configured to allow cooling air to enter the channel.

7. A ring according to claim 6, wherein the air-inlet orifices are located in the outer support part.

8. A ring according to claim 1, wherein each segment comprises a first circumferential end comprising an annular support rim extending circumferentially and configured to coming to bear on the radially outer surface of a second circumferential end of an adjacent segment.

9. A ring according to claim 8, wherein each segment has a first zone extending circumferentially between the first circumferential end of the segment and the connecting zone and a second zone extending circumferentially between the second circumferential end of the segment and the connecting zone a circumferential dimension of the first zone being smaller than a circumferential dimension of the second zone.

10. A ring according to claim 6, wherein at least some of the air-inlet orifices is located at the level of at least one connecting zone.
